(19) United States
(12) Patent Application Publication
(10) Pub. No.: US 2005/0097765 A1
(43) Pub. Date: May 12, 2005

(54) Method and apparatus for establishing a positioning reference frame for a surface having hidden features where the reference frame is aligned to one or more of the hidden features

(75) Inventors: Joseph Sorensen, Bozeman, MT (US); Charles Poremba, Bozeman, MT (US)

Correspondence Address: Gideon Gimlan;MacPHERSON KWOK CHEN & HEID llp, Suite 226, 1762 Technology Drive, San Jose, CA, 95110, US

(73) Assignee: Zircon Corporation

(21) Appl. No.: 10/982,095

(22) Filed: Nov. 5, 2004

Related U.S. Application Data
(60) Provisional application No. 60/518,246, filed on Nov. 7, 2003.

(51) Int. Cl. B25H 7/00

(52) U.S. Cl. 33/666

(57) ABSTRACT

Methods and structures are disclosed for establishing a positioning reference frame for a work surface having one or more hidden features (such as studs) where the hidden features are detectable by way of machine-aided sensing. One method geometry, proximate to the surface, so that one or more of the hidden features can be detected and located with machine-aided sensing. One or more sensor modules are attached to the guiding frame and at least a first of the sensor modules is movable along the guiding frame. The first sensor module provides machine-aided sensing of at least a corresponding first of the hidden features. The first sensor module and/or guiding frame are moved relative to one another so that the relatively moved components become aligned to the first hidden feature according to a desired orientation.

### CROSS REFERENCE TO CO-OWNED APPLICATION

The following copending U.S. provisional patent application is owned by the owner of the present application, its disclosure is incorporated herein by reference, and benefit of its filing date is claimed:

(A) Ser. No. 60/518,246 filed Nov. 7, 2003 by Joe Sorenson and Chuck Poremba by way of Express Mail submission EL-738028532-US and which is originally entitled, “Integrated Marketing [sic] Device.”

### FIELD OF DISCLOSURE

The present invention relates generally to construction-assisting tools such as inclinometers, rulers and markers; and methods of use.

### DESCRIPTION OF RELATED ART

Construction assisting tools such as hand-held rulers, inclinometers and speed squares are routinely used in the marking of different workpiece surfaces including wood, drywall, glass, metal and stucco.

### SUMMARY

Structures and methods are provided in accordance with the present invention for improving over prior construction assisting tools and methods.

In accordance with the invention, a method is disclosed for establishing a positioning reference frame for a surface having one or more hidden features (such as studs for example) where the hidden features are detectable by way of machine-aided sensing. The method includes the step of providing a guiding frame of predefined geometry, proximate to the surface, so that one or more of the hidden features can be detected and located with machine-aided sensing. One or more sensor modules are attached to the guiding frame and at least a first of the sensor modules is movable along the guiding frame. The first sensor module provides machine-aided sensing of at least a corresponding first of the hidden features. In accordance with the invention, the first sensor module and/or guiding frame are moved relative to one another so that the relatively moved components become aligned to the first hidden feature according to a desired orientation. The orientation is defined in one embodiment as locating the first sensor module at a corresponding first position along the guiding frame when the first sensor module detects and locates the corresponding first hidden feature and causing a linear portion of the guiding frame to be level or plumb relative to gravity. Once alignment with the hidden feature is attained, a user can use the aligned guiding frame to locate further positions on the work surface, for example, further positions that are spaced apart according to predetermined distances and/or orientations relative to one another and relative to the aligned guiding frame. Other aspects of the invention will become apparent from the below detailed description.

### BRIEF DESCRIPTION OF THE DRAWINGS

The below detailed description section makes reference to the accompanying drawings, in which:

FIG. 1 is a plan top view of an inclinometer in accordance with the invention having a plurality of slidable modules;

FIG. 2 is a perspective view of a level having a sliding marker module;

FIG. 3 is a perspective view of a studfinder having an integrated marker module and of a sampling of marks which can be made using the marker module;

FIG. 4 is a perspective view of a tapemeasure unit having an integrated marker module;

FIG. 5 is a plan top view of a speed square having an integrated marker module;

FIG. 6 shows a plan top view of a speed square having an integrated inclinometer and marker module and further shows magnified views of the integrated module;

FIG. 7 is a perspective view of a tapemeasure unit having a slidable and stowable marker module; and

FIG. 8 is a perspective view of another tapemeasure unit having a slidable marker module.

### DETAILED DESCRIPTION

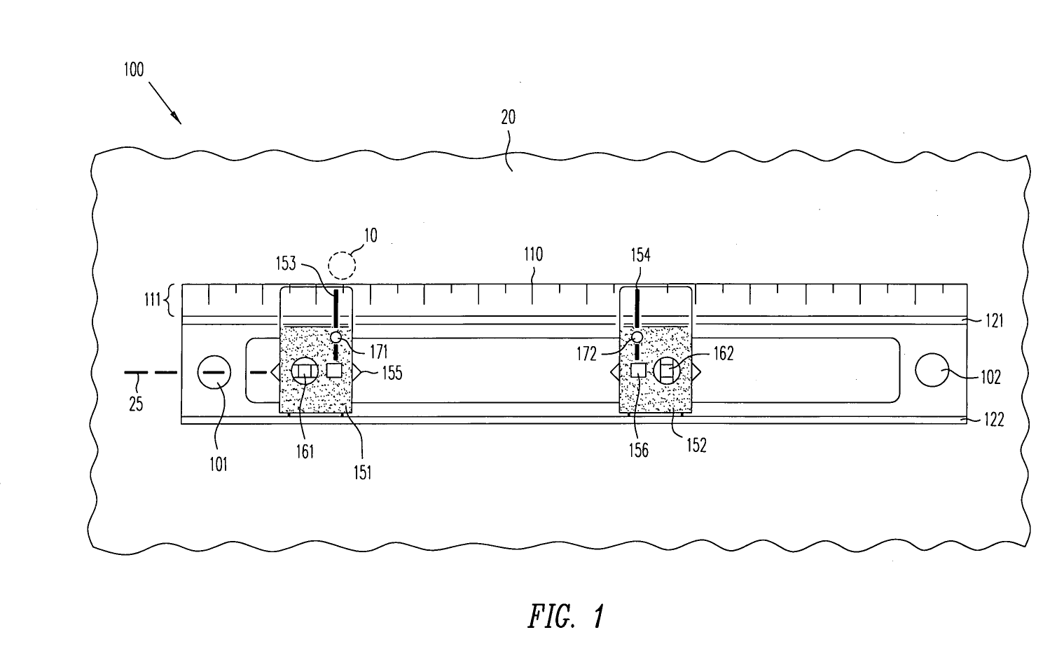

Referring to FIG. 1, an inclinometer 100 is provided to indicate level and plumb conditions. Inclinometer 100 has ruled markings 110 positioned on its outward edge face 111 as shown. The inclinometer 100 has first and second guides, 121 and 122.

One or more sliding modules, 151, 152 are provided to slide transversely upon the guides 121, 122. Bubble vials 161, 162 are provided to indicate the level and/or plumb conditions of the inclinometer 100. The bubble vials 161, 162 can be mounted either on the inclinometer 100, or within the sliding module/s 151, 152. Each module 151, 152 also contains a sensing device 171, 172 to indicate stud locations (one stud shown in phantom at 10) hidden behind a work surface 20. A corresponding pointer 153, 154 is mounted to extend on a see-through portion of the module/s 151, 152; over the outward edge face 111 having the ruled markings 110 to reference its location relative to the ruled markings. One module (e.g. 151) can indicate a hidden feature such as a stud location (10), for example. The other module (e.g. 152) can then indicate another location which is a given distance from the first, and which is level or plumb with respect to the first location.

Each module 151, 152 also contains an integrated marking device, namely, a self-inking printer 155, 156. When suitable locations are found with respect to distance, level or plumb, or with respect to measurements from a stud location; a mark 25 can be printed upon the work surface 20. Because of the nature of self-inking printers the marks 25 can take the form of either dots, continuous lines, descriptive type, circles, arrows, etc. (See also FIG. 3, Example B.)

The inclinometer 100 also incorporates a view port 101, 102 at either end, to allow measurements, stud locations, plumb or horizontal indications to be made relative to previous marks 25 made upon a surface (e.g., 20). Thus, an inclinometer 100 with ruled markings 110 and movable sensing module/s 151, 152 has been illustrated that is capable of locating and/or marking work surface positions that are desired distances away from, and optionally level or plumb with, other work surface positions, including those associated with hidden features such as studs (e.g., 10) detected by the integrally attached and on-guide slidable sensing module/s 151, 152.

The Integrated Marking Device

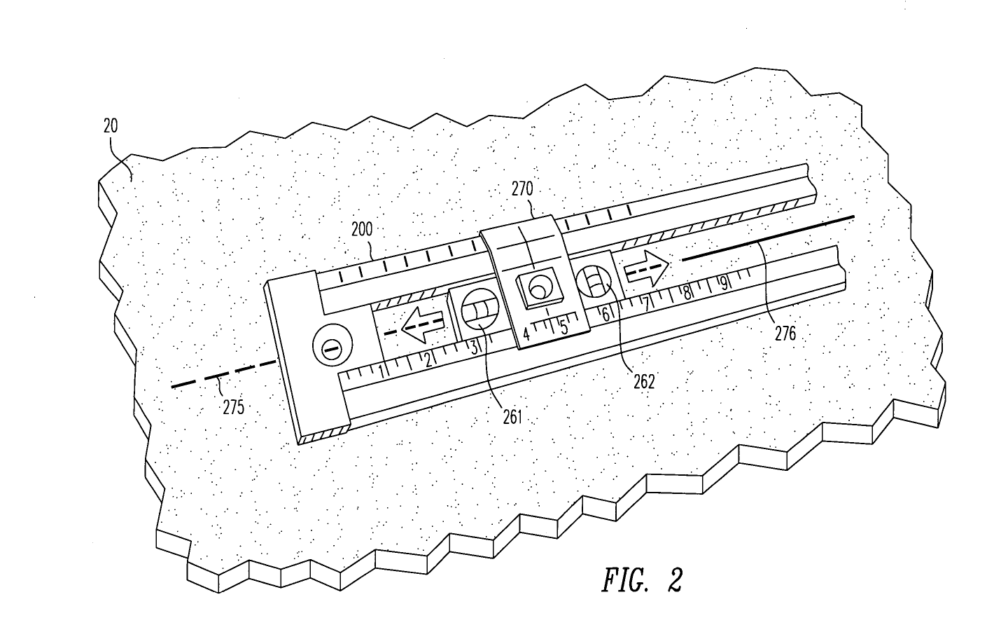

In accordance with a broader aspect of the present invention, a marking device may comprise a self-inking pad mounted in a pad frame. The pad frame is positioned within a guide frame, and can move reciprocally within the guide frame to different positions, including an extended or a retracted position. Referring to FIG. 2 (Example D) the illustrated marking device 270 is attached to the illustrated level 200. In this application, the pad frame of the marking device 270 can either stay in position or slide to various different positions along the central elongated opening in the level 200. The illustrated level 200 includes horizontal and vertical bubble vials, 261, 262; allowing it to indicate a level or plumb condition. Then, either single marks 275, or a long continuous mark 276 can be printed that is level or plumb.

Referring to FIG. 3 (Example B) the marking device 370 is attached to a stud finder 350. When the stud finder 350 indicates a stud (not shown, see 10 of FIG. 1), a mark can be printed that is referenced to that specific location. Sample marks are shown at 375.

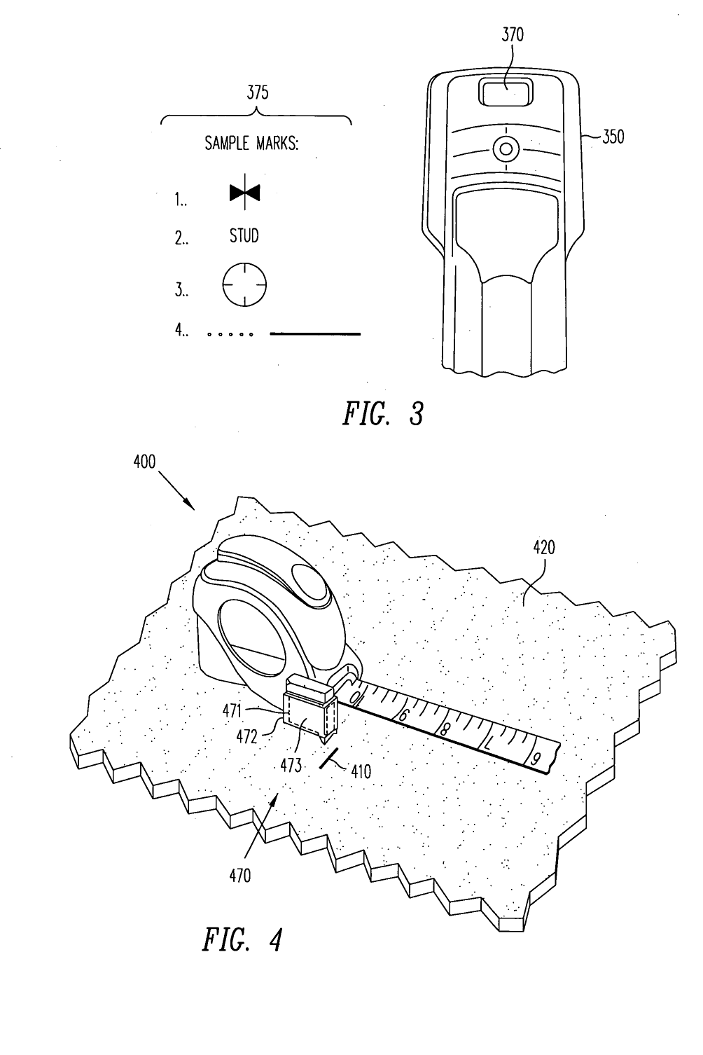

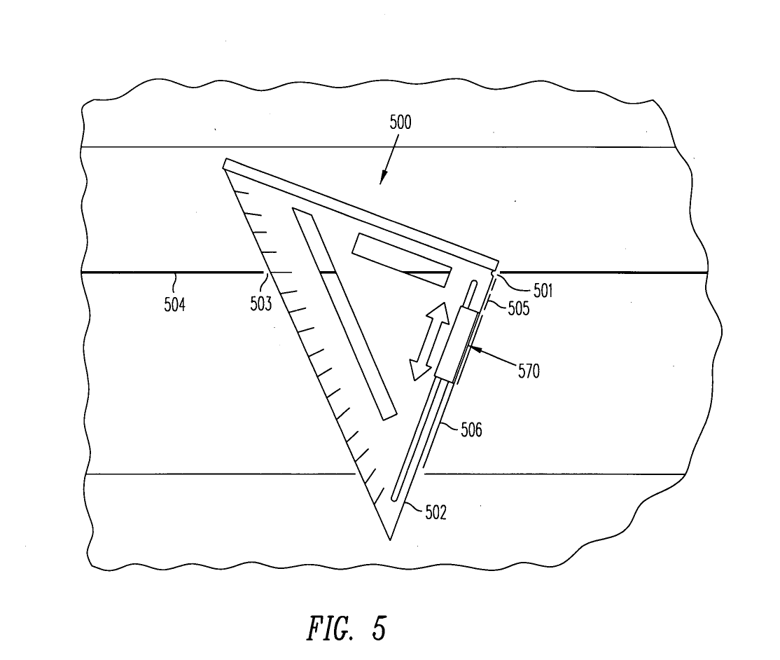

Referring to FIG. 4 (Example A) the marking device 470 includes a pad frame 471 that is movably attached to the case of a tape measure 400. When the pad frame 471 is moved reciprocally to an extended position along guide frame 472, the self-inking pad 473 enables the printing of a mark 410 on workpiece 420 where the mark 410 is referenced to a specific measurement (e.g., “10”) indicated by the tape measure 400.

Referring to FIG. 5 (Example C) the marking device (570) is attached to a speed square 500 swiveled about swivel point 501. In this application, the pad frame 570 can either stay in position or slide laterally along an edge 502 of the speed square 500. The swiveled speed square indicates the desired angle at 503 in the illustration, where the angle indication mark 503 is along a predefined line 504 (e.g., horizontal line) also extending through swivel point 501. Either single marks 505, or a long continuous mark 506 can be printed that is referenced to the desired angle.

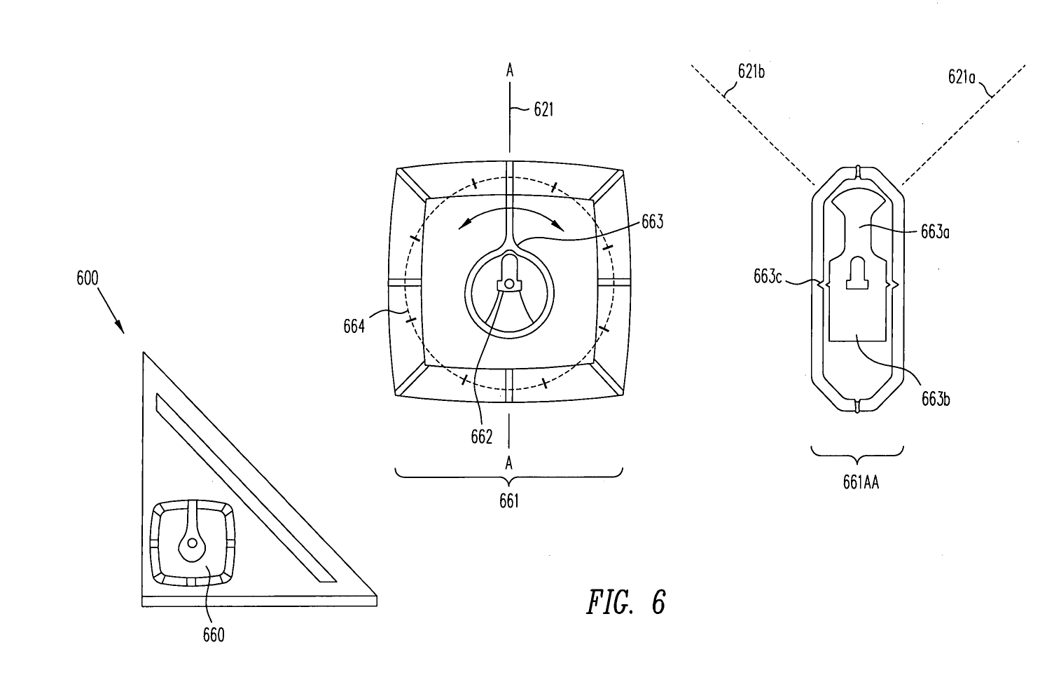

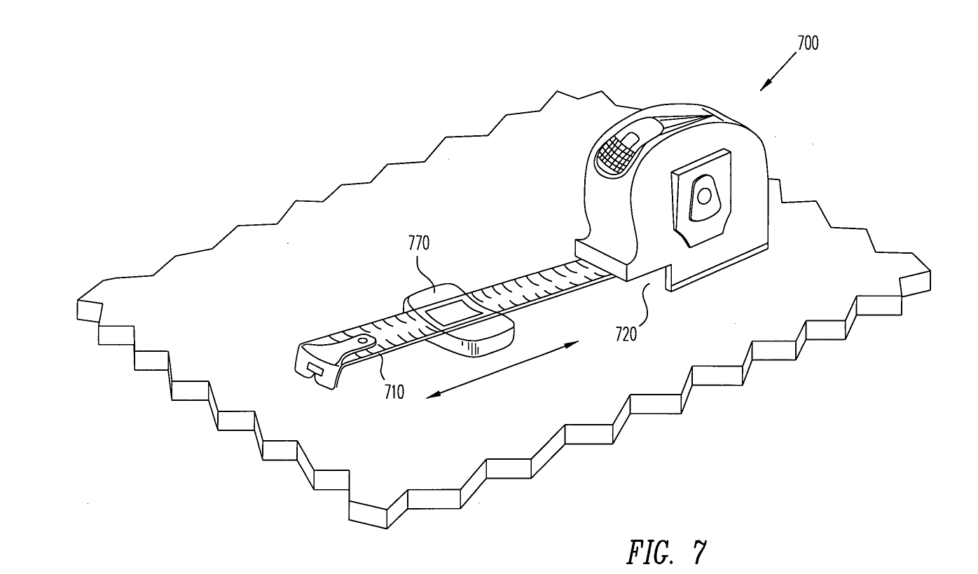

FIG. 6 (Example G) shows a speed square 600 having a inclinometer 660 mounted in it. As shown in enlarged view 661, the inclinometer 660 may include a pivotally-mounted LED 662 which projects a beam of light or focused light onto adjacent surfaces to thereby identify the plumb line 621. Pivoting pointer or light track 663 follows circular path 664 as the speed square is rotated 360°. An offset is provided between the pivot point of the LED support and its surrounds so that the LED can always point up as shown due to actuation by its lower mass 663b. The inclinometer may include markings at least at the 90 degree and 45 degree rotations about its housing. The cross sectional view at 661AA (taken along section line A-A of view 661) shows the pivoting LED light tracker 663a in cross section with the path of the fanned-out light beam indicated by dashed lines 621a and 621b. The tracker pivot is at 663c. Thus, it is seen in accordance with the invention that a speed square 600 may be provided with a lighted inclinometer 660. It is understood that the lighted inclinometer/speedsquare 600 of FIG. 6 can be combined with the teachings of the inclinometer shown in FIG. 1 and the speedsquare shown in FIG. 5.

In some embodiments (FIG. 7, Example E), a cut-out 720 may be provided in tape case 700 for storing a slidable tape marker 770 that slides along the graduated measurement tape 710. When the pad frame of marker 770 is in the retracted position, the self-inking pad is protected from debris, unintentional printing, and damage.

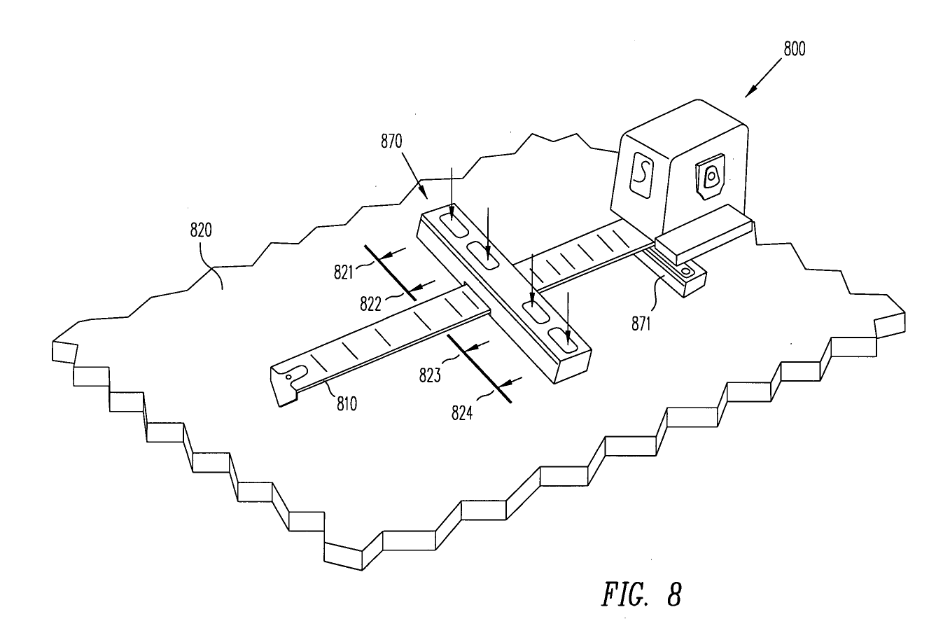

FIG. 8 (Example F) shows yet another embodiment in which an elongated stamp pad 870 is mounted at right angles to and reciprocally on the ruled tape 810 so that spaced apart marks can be made on a work piece 820 such as shown at 821-824. A second stamp device 871 may also mount to the tape measure case 800 as shown.

The present disclosure of invention is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, and/or use of equivalent functional steps for steps described herein. Such insubstantial variations are to be considered within the scope of what is contemplated here. Moreover, if plural examples are given for specific means, or steps, and extrapolation between and/or beyond such given examples is obvious in view of the present disclosure, then the disclosure is to be deemed as effectively disclosing and thus covering at least such extrapolations.

Reservation of Extra-Patent Rights, Resolution of Conflicts, and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

Unless expressly stated otherwise herein, ordinary terms have their corresponding ordinary meanings within the respective contexts of their presentations, and ordinary terms of art have their corresponding regular meanings within the relevant technical arts and within the respective contexts of their presentations herein.

Given the above disclosure of general concepts and specific embodiments, the scope of protection sought is to be defined by the claims appended hereto. The issued claims are not to be taken as limiting Applicant's right to claim disclosed, but not yet literally claimed subject matter by way of one or more further applications including those filed pursuant to 35 U.S.C. §120 and/or 35 U.S.C. §251.

1. A method for establishing a positioning reference frame for a surface having one or more hidden features where the hidden features are detectable by way of machine-aided sensing, the method comprising:
(a) providing a guiding frame of predefined geometry, proximate to the surface, where the proximity is such that machine-aided sensing can be used to detect and locate one or more of the hidden features, where one or more sensor modules is attached to the guiding frame and at least a first of the sensor modules is movable along the guiding frame and provides machine-aided sensing for detecting and locating a corresponding first of the hidden features;
(b) moving one of the first sensor module and guiding frame relative to one another so that the moved one of the first sensor module and guiding frame becomes aligned at least to the first hidden feature by an orientation that is defined by the first sensor module being at a corresponding first position along the guiding frame when the first sensor module detects and locates the corresponding first hidden feature; and
(c) using the guiding frame after the frame has become aligned at least to the first hidden feature for locating further positions on the surface that are spaced apart according to predetermined distances and/or orientations relative to one another and relative to the aligned guiding frame.

2. The reference frame establishing method of claim 1 wherein a second of the sensor modules is attached to the guiding frame and the second sensor module detects the orientation of an invisible force field [gravity], the method further comprising:
(d) using the second sensor module, prior to said locating of further positions, to further align the guiding frame according to a predefined orientation relative to the invisible force field.

3. The reference frame establishing method of claim 1 wherein the guiding frame includes distance-measuring indicia, the method further comprising:
(d) using the distance-measuring indicia of the guiding frame to locate one or more of said further positions.

4. The reference frame establishing method of claim 1 wherein the guiding frame includes one or more movable, surface markers movable along the guiding frame, the method further comprising:
(d) using the one or more movable markers to mark the locations on said surface of the one or more further positions.

5. A work-assisting tool comprising:
(a) a first guide of predefined first geometry; and
(b) a first movable module attached to the first guide, where movement of the first movable module is guided at least by the predefined first geometry of the first guide, and where the first movable module includes:
(b.1) a first hidden feature sensor adapted to detect and locate the position of a hidden feature.

6. The work-assisting tool of claim 5 wherein said first hidden feature sensor is adapted to detect and locate the positions of studs hidden under a work surface.

7. The work-assisting tool of claim 5 wherein:
(a.1) said first guide is mounted adjacent to a marked face having distance defining indicia marked thereon; and
(a.2) at least a portion of said first guide extends parallel to the distance defining indicia so that movement of the first movable module along the first guide can be measured relative to the distance defining indicia.

8. The work-assisting tool of claim 5 and further comprising:
(c) a first hidden force detector adapted to detect an orientation of a hidden force field extending about the first guide so that the first guide can be aligned at a predetermined angle relative to the orientation of the hidden force field,
where the first hidden force detector is either fixedly coupled to the first guide or mounted to the first movable module or mounted to another movable module where said other movable module is attached to the first guide so that movement of the other movable module is guided at least by the predefined geometry of the first guide.

9. The work-assisting tool of claim 5 and further comprising:
(c) a second guide of predefined second geometry; and
(b.2) where the first movable module is further attached to the second guide so that movement of the first movable module is guided at least by the predefined second geometry of the second guide.

10. The work-assisting tool of claim 5 and further comprising:
(c) a second movable module attached to the first guide, so that movement of the second movable module is guided at least by the predefined first geometry of the first guide.

11. The work-assisting tool of claim 10 wherein the second movable module includes at least one of:
(c.1) a second hidden feature sensor adapted to detect and locate the position of said hidden feature;
(c.2) a hidden force detector adapted to detect an orientation of a hidden force field extending about the first guide so that the first guide can be aligned at a predetermined angle relative to the orientation of the hidden force field; and
(c.3) a self-inking printer adapted to print a predefined mark on a work surface underlying said first guide.

12. A method for locating points on a first surface, behind which are hidden one or more sensor-detectable features, the method comprising:
(a) providing a guiding frame adjacent to the first surface;
(b) orienting the guiding frame relative to a plumb or level orientation;
(c) moving a first sensor module along the provided and oriented guiding frame;
(d) detecting one or more of said hidden and sensor-detectable features with said first sensor module; and
(e) locating one or more points on the first surface where the located points are spaced apart from the detected, sensor-detectable features and/or from one another by predetermined distances measured along the guiding frame.

13. The method of claim 12 wherein one or more inclination indicators are coupled to at least one member of the combination of said guiding frame and said first sensor module, and
said orienting of the guiding frame includes using one or more of said inclination indicators.

14. The method of claim 12 wherein said guiding frame includes a linear section, and
said moving of the first sensor module includes moving the first sensor module along the linear section.

15. The method of claim 12 wherein said first sensor module includes a stud-finder, and
said detecting of at least one sensor-detectable feature comprises using the stud-finder to find a hidden stud.

16. The method of claim 12 and further comprising:
marking at least one of the located points, wherein a self-inking marking device is movably coupled to at least one of the guiding frame and first sensor module, and said marking includes using the marking device to mark the at least one of the located points.

17. A locating device for locating points on a first surface, behind which are hidden one or more sensor-detectable features, the locating device comprising:
(a) a guiding frame adapted to be provided adjacent to the first surface;
(b) orienting means for orienting the guiding frame relative to a plumb or level orientation;
(c) a movable first sensor module operatively coupled to move along the guiding frame, the first sensor module being adapted to detect one or more of said hidden and sensor-detectable features; and
(e) distance measuring means operatively coupled to at least one of the guiding frame and first sensor module for locating one or more points on the first surface where the located points are spaced apart from the detected, sensor-detectable features and/or from one another by predetermined distances measured along the guiding frame by the distance measuring means.
